(19) United States
(12) Patent Application Publication
(10) Pub. No.: US 2012/0197721 A1
(43) Pub. Date: Aug. 2, 2012

(54) ADVERTISING IN ELECTRONIC COMMUNICATIONS

(76) Inventors: Barrie John Munro, Queensland (AU); Mal Pratt, Queensland (AU); Lance Taylor, Mooloolaba (AU)

(21) Appl. No.: 13/190,003

(22) Filed: Jul. 25, 2011

Related U.S. Application Data
(60) Provisional application No. 61/369,967, filed on Aug. 2, 2010.

(30) Foreign Application Priority Data
Jul. 30, 2010 (AU) 2010100813
Jul. 30, 2010 (NZ) 587118

(51) Int. Cl. G06Q 30/02

(52) U.S. Cl. 705/14.55

(57) ABSTRACT

The method of advertising according to the present disclosure facilitates the delivery of categorized advertisements to recipients of electronic communications such as emails, SMS messages, MMS messages or instant messaging (IM) messages. In one aspect, the method generally comprises the steps of (i) receiving an electronic communication intended for one or more intended recipients, (ii) inserting one or more selectable advertisement categories into the electronic communication to form a modified electronic communication, and (iii) sending the modified electronic communication to the one or more intended recipients. In another aspect of the disclosure, the method of advertising is associated with a prize draw where a sender's entry of the prize draw is made by the sender sending an electronic communication inserted with categorized advertisements.

### PRIORITY CLAIM

This application claims the benefit of and priority to U.S. Provisional Patent Application No. 61/369,967, filed on Aug. 2, 2010, this application also claims the benefit of and priority to Australian Patent Application No. 2010100813, filed on Jul. 30, 2010, this application also claims the benefit of and priority to New Zealand Patent Application No. 587118, filed on Jul. 30, 2010, the entire contents of which are each incorporated by reference herein.

### FIELD

The present disclosure relates generally to advertising in electronic communications, and particularly to categorized advertising in electronic communications.

### BACKGROUND

Some web-based email services providers offer free email services by inserting advertisements or tag lines in emails sent by their users. Apart from the free email service there is little incentive for email senders to send emails with advertisements. Moreover the number of advertisements in an email is often limited to one to a few due to clutter and general antipathy of email users towards email advertising. The few number of advertisements in an email means that the probability of an email recipient finding an advertisement of interest, and hence worth clicking and viewing, is small.

### SUMMARY

According to a first aspect of the present disclosure there is provided a method of advertising in an electronic communication, the method comprising the steps of:

receiving an electronic communication;

inserting one or more selectable advertisement categories into the electronic communication to form a modified electronic communication, the one or more selectable advertisement categories being configured to be displayed upon display of the modified electronic communication and each being associated with one or more advertisements; and

sending the modified electronic communication.

Preferably the step of inserting one or more selectable advertisement categories into the electronic communication includes the step of enabling the electronic communication to receive a first input for selecting one of the one or more selectable advertisement categories. More preferably the first input includes a mouse click, a key press, a tactile input or any combination thereof.

Preferably the step of inserting one or more selectable advertisement categories into the electronic communication includes the step of inserting the one or more advertisements configured to be displayed upon selection of a respective one of selectable advertisement categories.

Preferably the method further comprises the step of enabling the electronic communication to receive a second input for selecting one of the one or more advertisements. More preferably the second input includes a mouse click, a key press, a tactile input or any combination thereof.

Preferably the step of inserting one or more selectable advertisement categories into the electronic communication includes the steps of:

causing a first subset of the one or more advertisement categories to be displayed upon the display of the modified electronic communication; and

causing a second subset of the one or more advertisement categories to be displayed upon receiving a third input.

More preferably the step of causing a second subset of the one or more advertisement categories to be displayed upon receiving a third input includes the step of causing the first subset of the one or more advertisement categories to cease to be displayed.

Preferably the third input includes a mouse click, a key press, a tactile input or any combination thereof.

Alternatively the step of inserting one or more selectable advertisement categories into the electronic communication includes the steps of:

causing a first subset of the one or more advertisement categories to be displayed upon the display of the modified electronic communication; and

causing a second subset of the one or more advertisement categories to be displayed after a predetermined time delay has passed.

More preferably the step of causing a second subset of the one or more advertisement categories to be displayed after a predetermined time delay has passed includes the step of causing the first subset of the one or more advertisement categories to cease to be displayed.

Preferably the step of inserting one or more selectable advertisement categories into the electronic communication includes the step of embedding a user interface in the electronic communication. More preferably the step of embedding a user interface includes the step of embedding a user interface configured to display the one or more selectable advertisement categories. Even more preferably the step of embedding a user interface includes the step of embedding a user interface in Flash, JavaScript, hypertext mark-up language (HTML) or a combination thereof.

Alternatively the step of inserting one or more selectable categories of advertisements into the electronic communication includes the step of embedding a hyperlink linked to each of the one or more selectable advertisement categories in the electronic communication.

Preferably the step of receiving an electronic communication includes the step of receiving an electronic communication intended for an intended recipient. More preferably the step of sending the modified electronic communication includes the step of sending the modified electronic communication to the intended recipient.

Preferably the one or more advertisements are configured to be displayed based partly on the intended recipient. More preferably the one or more advertisements are configured to be displayed based partly on a physical location associated with the intended recipient. Even more preferably the one or more advertisements are configured to be displayed in an order based partly on the physical location associated with the intended recipient.

Preferably the electronic communication includes an electronic mail (email), a short message service (SMS) message, a Multimedia Messaging Service (MMS) message or an instant messaging (IM) message.

Preferably the one or more selectable advertisement categories include one or more of news, entertainment, sports, food and dining, automobile, flights and holidays, finance, television, retail and shopping.

According to a second aspect of the present disclosure there is provided a system for advertising in an electronic communication, the system comprising:

receiving means for receiving an electronic communication;

modification means for inserting one or more selectable advertisement categories into the electronic communication to form a modified electronic communication, the one or more selectable advertisement categories each being associated with one or more advertisements and configured to be displayed upon display of the electronic communication; and transmission means for sending the modified electronic communication.

According to a third aspect of the present disclosure there is provided an electronic communication comprising:

an electronic message; and

one or more selectable advertisement categories each being associated with one or more advertisements and configured to be displayed upon display of the electronic message.

According to a fourth aspect of the present disclosure there is provided a method of advertising in an electronic communication, the method comprising the steps of:

receiving at least one electronic communication from a sender eligible for a reward;

inserting an advertisement or an advertisement category into each of the at least one electronic communication to form at least one modified electronic communication, the advertisement or the advertisement category being configured to be displayed upon display of the at least one modified electronic communication;

sending the at least one modified electronic communication;

increasing a probability of the sender to be awarded the reward.

Preferably the step of increasing a probability of the sender to be awarded the reward includes the step increasing the probability based on the number of the at least one modified electronic communication sent.

Preferably the step of receiving at least one electronic communication includes the step of receiving at least a predetermined number of electronic communications. More preferably the step of receiving at least a predetermined number of electronic communications includes the step of receiving at least a predetermined number of electronic communications over a predetermined period of time.

Preferably the step of receiving at least one electronic communication includes the step of receiving at least one qualified electronic communication. More preferably the step of receiving at least one qualified electronic communication includes the step of receiving at least one electronic communication satisfying a predetermined characteristic. Even more preferably the step of receiving at least one electronic communication satisfying a predetermined characteristic includes the step of receiving at least one electronic communication of at least a predetermined message length.

According to a fifth aspect of the present disclosure there is provided a system for advertising in an electronic communication, the system comprising:

receiving means for receiving at least one electronic communication from a sender eligible for a reward;

modification means for inserting an advertisement or an advertisement category into each of the at least one electronic communication to form at least one modified electronic communication, the advertisement or the advertisement category being configured to be displayed upon display of the at least one modified electronic communication;

transmission means for sending the at least one modified electronic communication; and;

processing means for increasing a probability of the sender to be awarded the reward.

According to a sixth aspect of the present disclosure there is provided a computer-readable medium containing instructions for a computer to execute the method of the first aspect.

According to a seventh aspect of the present disclosure there is provided a computer-readable medium containing instructions for a computer to execute the method of the fourth aspect.

Additional features and advantages are described in, and will be apparent from, the following Detailed Description and the figures.

### BRIEF DESCRIPTION OF THE ACCOMPANYING DRAWINGS

FIG. 1 is a schematic diagram illustrating a system for delivering emails.

FIG. 2 is a display of an example of an unmodified electronic communication delivered by the system shown in FIG. 1.

FIG. 3 is a schematic diagram illustrating a system for advertising in emails in accordance with the present disclosure.

FIG. 4 is a first display of an example of a modified email in accordance with the present disclosure.

FIG. 5 is a second display of the example of a modified email shown in FIG. 4.

FIG. 6 is a third display of the example of a modified email shown in FIG. 4.

FIG. 7A is a first display of another example of a modified email in accordance with the present disclosure.

FIG. 7B is a second display of the example of a modified email as shown in FIG. 7A.

### DETAILED DESCRIPTION

One aspect of the present disclosure relates generally to a method of advertising in an electronic communication. The method facilitates the delivery of categorized advertisements to recipients of electronic communications such as electronic mails (emails), short message service (SMS) messages, Multimedia Messaging Service (MMS) messages or instant messaging (IM) messages. It is envisaged that Internet service providers (ISPs), email service providers, webmail service providers, email gateways, SMS/MMS/IM message gateways may be configured with the appropriate system and software or any computer readable medium containing instructions for a computer or processor to execute this method of advertising.

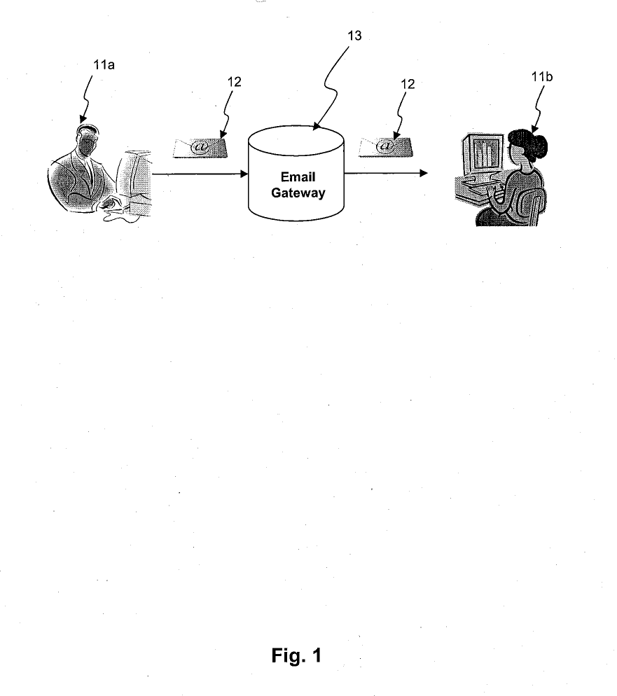

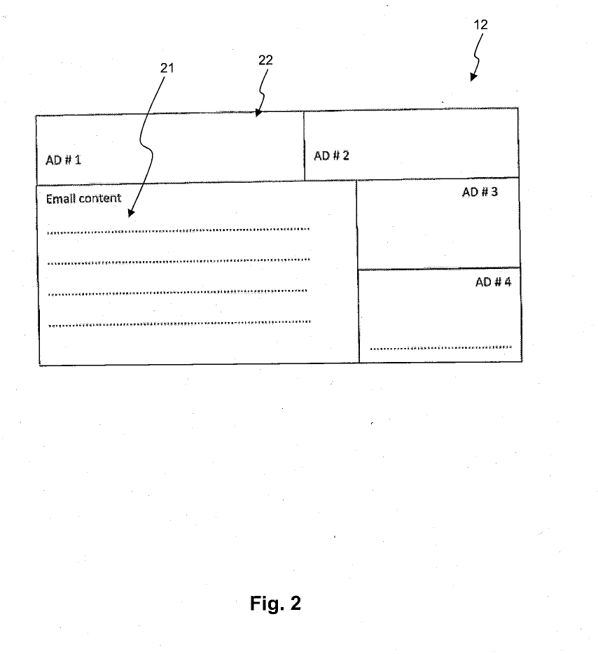

FIG. 1 illustrates a simplified, existing email gateway for delivering emails. As shown in FIG. 1, a sender 11a may send an email 12 to an intended recipient 11b via an email gateway 13 provided by, for example, the sender's Internet service provider (ISP). The email gateway 13 having received the email 12 may recognize a recipient's email address contained in the header of the email 12, and thus forwards the email 12 to the recipient's ISP or email service provider. The recipient's ISP or email service provider may store a copy of the email 12 in an email storage server for retrieval by the recipient when the recipient 11b uses a computer to connect to the email storage server. Without the present disclosure, the email 12 when delivered to the recipient 11b and displayed on the recipient's computer (e.g. on the display of the recipient's computer) may appear, for example, as that shown in FIG. 2. The email 12 may be displayed with content 21 of the email, such as a message, image or video from the sender to the recipient. The email 12 may also be displayed with an advertisement 22.

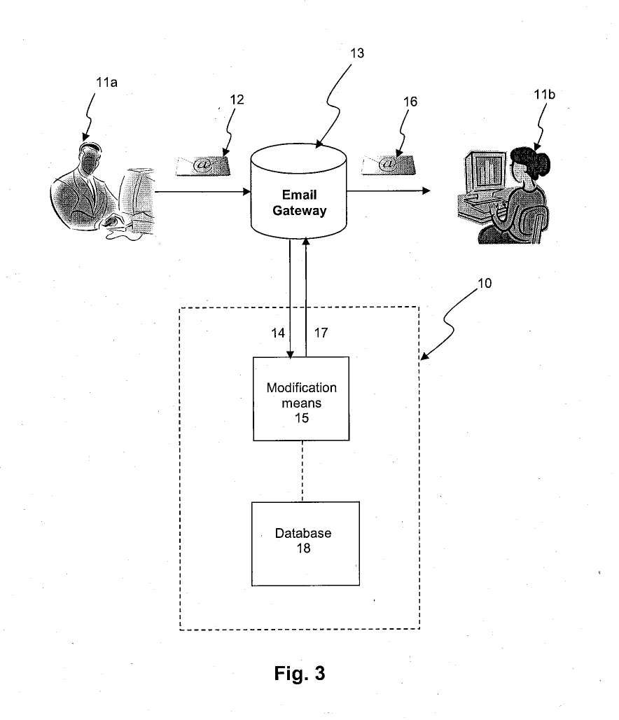

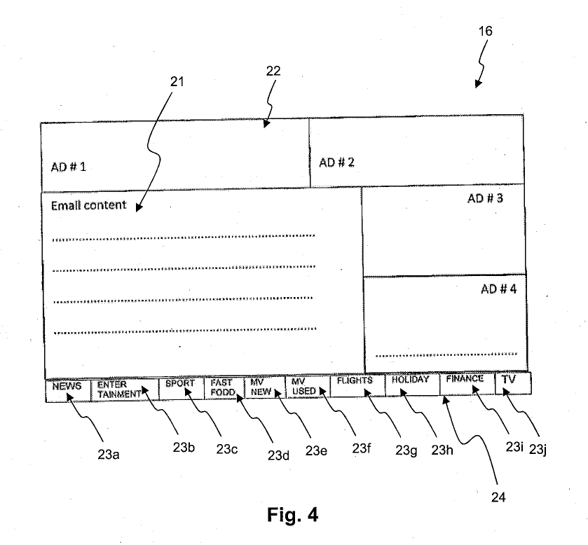

FIG. 3 illustrates an embodiment of a system 10 for executing a method of advertising in electronic communications in accordance with the present disclosure. The method generally comprises the steps of (i) receiving an electronic communication intended for one or more intended recipients, (ii) inserting one or more selectable advertisement categories into the electronic communication to form a modified electronic communication, and (iii) sending the modified electronic communication to the one or more intended recipients. The system 10 shown in FIG. 3 is suitable for modifying an email 12 to become a modified email 16, such as that shown in FIG. 4, for delivering categorized advertisements. The system 10 may be a stand-alone computer or processor, or it may be embodied as software or computer-readable medium, embedded in a computer or a processor such as the email gateway 13, containing instructions for the computer or the processor to execute the method of advertising in electronic communications.

Referring back to FIG. 3, the email 12 received by the email gateway 13 and before being sent to the recipient 11b may first be sent to the system 10 for insertion of the one or more selectable advertisement categories. The system 10 generally comprises (i) receiving means 14 for receiving an email 12, modification means 15 for inserting one or more selectable advertisement categories into the received email 12 to form a modified email 16, and (iii) transmission means 17 for sending the modified email 16 back to the email gateway 13 for delivery to the recipient 11b. The modification means 15 may retrieve from a database 18 the advertisement categories (and the associated advertisements) for insertion into the email 12. The modification means 15 may be a software program written in a scripting language, such as AppleScript or Microsoft® ScriptIt, to insert or append into the unmodified email 12 a piece of software code representing the selectable advertisement categories.

FIG. 4 shows an example of a modified email 16 when displayed on the recipient's computer. The selectable advertisement categories 23a to 23j are configured to be displayed upon display of the content 21 or any other parts of the modified email 16. Each of the selectable advertisement categories 23a to 23j is associated with one or more advertisements. For example, the selectable advertisement categories may include news, entertainment, sports, food and dining, automobile, flights and holidays, finance, television, retail and shopping. Associated with the selectable “news” category may be advertisements of different news service providers, such as CNN and BBC. Similarly, associated with the selectable “food and dining” category may be advertisements of different food outlets or restaurants. Once an advertisement category is selected, the associated advertisements may be displayed or accessed in one of a number of ways, some of which are described in more detail below. Such categorized advertising, which is akin to the Yellow Pages telephone directory, allows a recipient of the modified email 16 to be able to select a desired advertisement category, and thereby access the one or more advertisements associated with that advertisement category.

In the embodiment shown in FIG. 4, the selectable advertisement categories 23a to 23j are displayed as icons in a user interface or a toolbar 24 embedded in the modified email 16. The toolbar 24 may be embedded using Flash, JavaScript or HTML such as HTML5 (or a combination thereof) to enable the modified email 15 to receive a first input, such as a mouse click, for selecting a particular advertisement category. For example, the selectable advertisement categories may be embedded as hyperlinks, such as HTML links. In this example, the “News” category hyperlink when selected or clicked on may cause a browser on the recipient's computer to download and display a “News” category webpage with a list of news service providers, such as CNN, BBC and Google News, associated with this category. The news service providers displayed in the list may themselves be HTML links, which when selected or clicked on may cause the recipient's computer to download and display the website of the selected news service provider.

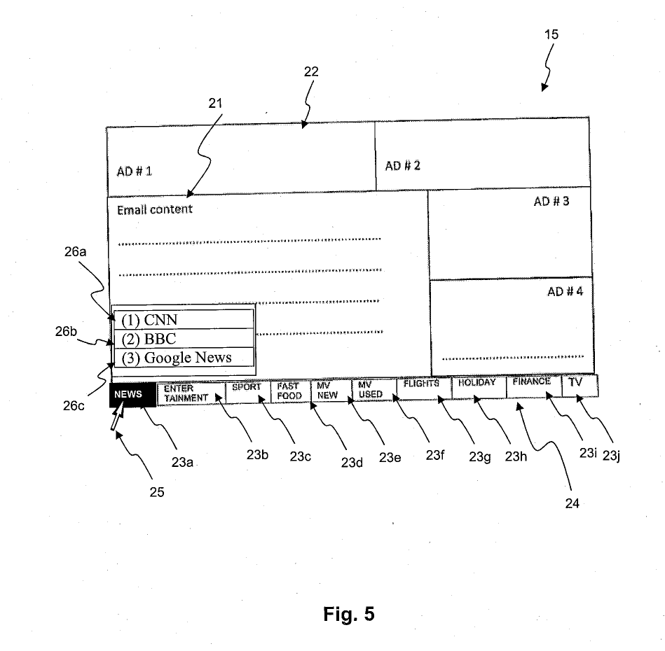

In some embodiments, as shown in FIG. 5, when the “News” category 23a is selected by a mouse click when the mouse cursor 25 is at or near the “News” category icon 23a, the embedded toolbar 24 may be configured to display icons of the one or more advertisements 26a to 26c near the “News” category 23a once it is selected or clicked on. The toolbar 24 may further be configured to enable the modified email 16 to receive a second input for selecting any one of the one or more advertisements 26a to 26c. For example, the news service provider “CNN” may be selected by a mouse click when the mouse cursor 25 is at or near the CNN icon 26a. After the news service provider CNN is selected, a web browser of the recipient's computer may download and display the CNN website.

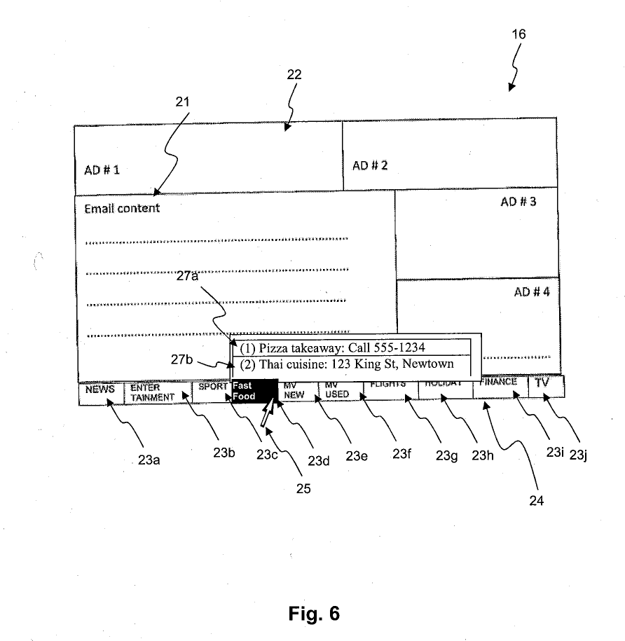

As another example as shown in FIG. 6, the “Fast Food” category 23d may be selected by a mouse click when the mouse cursor 25 is at or near the “Fast Food” category icon 23d. Once the “Fast Food” category 23d is selected, two advertisements 27a and 27b may be displayed, for example, with a telephone number to call for takeaway or an address of a restaurant. Accordingly the recipient of the modified email 16 may be able to access the CNN website or be provided with information such as a telephone number or an address for a restaurant or a fastfood shop or outlet within two mouse clicks. The toolbar of categorized advertising also creates less clutter in the email when viewed by the recipient.

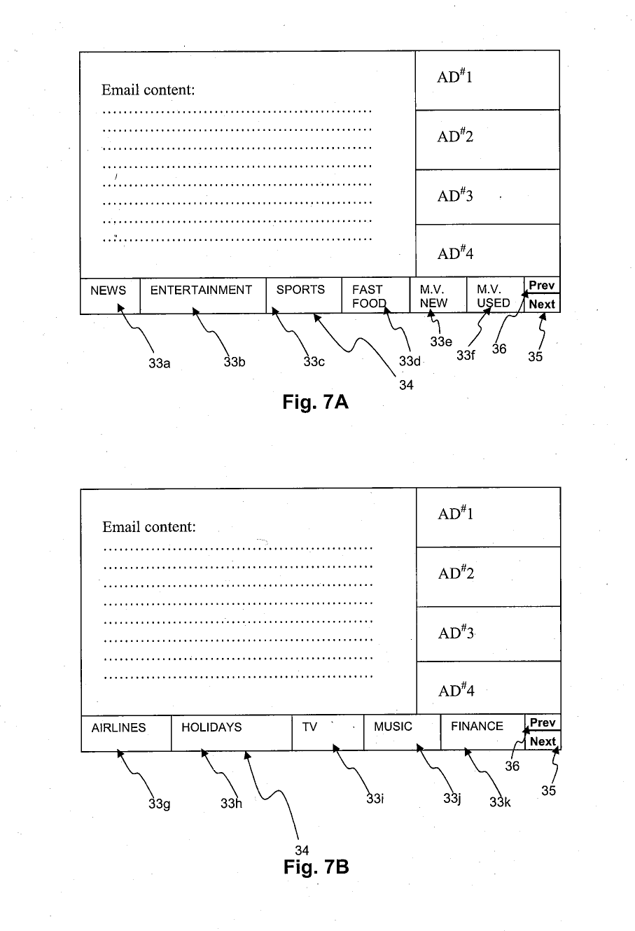

In some embodiments, the modified email when displayed may not be sufficiently sized to display all of the inserted advertisement categories. In this case, the toolbar may display only some but not all of the advertisement categories at any one time. For example, as shown in FIG. 7A, the toolbar 34 may display a first six (a first subset 33a to 33f) advertisement categories upon display of the modified email. The toolbar 34 may then be caused to display the next subset (a second subset 33g to 33k) of advertisement categories, as shown in FIG. 7B, when the recipient selects or clicks on a “Next” button 35 in the toolbar 34. Meanwhile the first subset of advertisement categories are ideally ceased to display. The toolbar may further be caused to display a third subset of advertisement categories when the recipient once again selects or clicks on a “Next” button 35 in the toolbar 34. Meanwhile the second subset of advertisement categories are ideally ceased to display. Alternatively, the recipient may click on a “Previous” or “Prey” button 36 in the toolbar 34 to cause the toolbar 34 to display the second subset of advertisement categories again. In some embodiments, the toolbar 34 may be configured to automatically display the next subset of advertisement categories after, for example, five seconds or a predetermined time delay has passed.

In some embodiments, other appropriate means of input may be used when, for example, the modified email or the modified electronic communication may not be viewed on a computer with a mouse, or may not even be viewed on a computer at all. For example, an appropriate input may be key presses such as pressing “N” for selecting the “News” category, and thereafter pressing “1” for selecting the CNN website. As another example, if the modified email is viewed on a device, such as a mobile device, a mobile phone or a laptop, with a touch-sensitive screen, the first input or the second input may take the form of a tactile input such as a finger tap on the screen of the device.

In some embodiments the advertisements categories and/or the associated advertisements may be based on the physical or geographical location of the recipient. For example, when the recipient selects the “Fast Food” category, ideally only advertisements of food outlets or restaurants within the locality of the recipient are displayed. Furthermore the advertisements may be ranked or displayed in an order according to the distance of the advertised food outlets or restaurants from the recipient.

In the embodiments where the method of advertising is applied to an email or IM message, the location of the recipient may be inferred from the Internet-protocol (IP) address of the recipient's ISP. In other embodiments where the method of advertising is applied to an MMS/SMS message, the location of the recipient may be inferred from the mobile number of the message recipient, or from the location of the mobile device, such as a mobile phone, of the message recipient via, for example, the global positioning system (GPS).

In another aspect of the present disclosure, the method of advertising aims to create incentives for senders of electronic communications to allow, for example, their ISPs or email service providers to insert categorized advertisements into their electronic communications. In this aspect, the method of advertising is associated with a prize draw where a sender's entry of the prize draw is made by the sender sending an electronic communication (or a minimum number of electronic communications) inserted with categorized advertisements. The method generally comprises the steps of (i) receiving at least one electronic communication intended for a recipient from a sender eligible for a reward, (ii) inserting an advertisement into each of the at least one electronic communication to form at least one modified electronic communication, the advertisement being configured to be displayed upon display of the at least one modified electronic communication, (iii) sending the at least one modified electronic communication to the recipient and (iv) increasing a probability of the sender to be awarded the reward. There may be a corresponding system comprising (i) receiving means for receiving the at least one electronic communication, (ii) modification means for inserting the advertisement, (iii) transmission means for sending the at least one modified electronic communication, and (iv) processing means for increasing the probability of the sender to be awarded the reward.

In one embodiment, the sender may be eligible for winning a monthly prize draw once the sender has authorized, for example, an ISP or email service provider to insert categorized advertisements into the sender's electronic communications. Without sending any electronic communications, the sender however may not have made an entry into the prize draw and will thus have a zero probability of winning a prize. As soon as the sender sends such an electronic communications, the system may allocate a prize ticket having a unique prize ticket number to the sender. The prize may be drawn by the system at the end of each month by randomly selecting a prize ticket number from the pool of prize ticket numbers. Accordingly, each time at least one electronic communication is received, inserted with categorized advertisements and sent, the sender may be allocated an additional prize ticket and therefore have his or her probability of winning the prize increased.

In one embodiment, the sender may be required to send more than a predetermined number of electronic communications in order to be allocated a prize ticket. For example, a prize ticket will be allocated to a sender for every 10 electronic communications the sender sends. Furthermore, the 10 electronic communications may be required to be sent over a predetermined period of time, such as one week.

In one embodiment, an electronic communication sent by the sender may be void for the purpose of a prize draw entry if the electronic communication is not a bona fide or qualified electronic communication. For example, the system may determine whether an electronic communication is qualified based on the length for the message contained in the electronic communication. If the message length is less than a predetermined length, the electronic communication may not be qualified. As another example, an email that is not successfully delivered to the recipient and thus causing a “delivery failed” error message to be sent to the email gateway may be determined by the system as not being a qualified email. Other predetermined characteristics of a non-qualified electronic communication include (i) a large proportion of words not being found in a dictionary, (ii) offensive, objectionable or obscene text, images or videos or (iii) spam or unsolicited junk mail.

Having described the preferred embodiments of the present disclosure, it should be apparent that the present disclosure has the following advantages:
Categorised advertising provides a quick and easy way for recipients of the electronic communications in accordance with the present disclosure to access advertisements or information when viewing the received electronic communications.
The number of advertisements may be increased by categorising without creating clutter in electronic communications.
The prize draw or the eligibility for a reward is a “something-for-nothing” scheme that creates an incentive for senders to have their electronic communications inserted with categorised advertisements.

Those skilled in the art will appreciate that the disclosure described herein is susceptible to variations and modifications other than those specifically described. For example, the system for advertising may be applicable to other forms of electronic communication such as SMS/MMS/IM messages. The user interface or toolbar may be embedded using any existing or future user interaction implementations other than Flash, JavaScript and HTML5. The advertisement categories may include other categories (such as music) than those shown or described. All such variations and modifications are to be considered within the ambit of the present disclosure the nature of which is to be determined from the foregoing description.

The invention is claimed as follows:

1. A method of advertising in an electronic communication, the method comprising the steps of:
receiving an electronic communication;
inserting one or more selectable advertisement categories into the electronic communication to form a modified electronic communication, the one or more selectable advertisement categories being configured to be displayed upon display of the modified electronic communication and each being associated with one or more advertisements; and
sending the modified electronic communication.

2. The method of claim 1, wherein the step of inserting one or more selectable advertisement categories into the electronic communication includes the step of enabling the electronic communication to receive a first input for selecting one of the one or more selectable advertisement categories.

3. The method of claim 2, wherein the first input includes a mouse click, a key press, a tactile input or any combination thereof.

4. The method of claim 1, wherein the step of inserting one or more selectable advertisement categories into the electronic communication includes the step of inserting the one or more advertisements configured to be displayed upon selection of a respective one of selectable advertisement categories.

5. The method of claim 1, further comprising the step of enabling the electronic communication to receive a second input for selecting one of the one or more advertisements.

6. The method of claim 5, wherein the second input includes a mouse click, a key press, a tactile input or any combination thereof.

7. The method of claim 1, wherein the step of inserting one or more selectable advertisement categories into the electronic communication includes the steps of:
causing a first subset of the one or more advertisement categories to be displayed upon the display of the modified electronic communication; and
causing a second subset of the one or more advertisement categories to be displayed upon receiving a third input.

8. The method of claim 7, wherein the step of causing a second subset of the one or more advertisement categories to be displayed upon receiving a third input includes the step of causing the first subset of the one or more advertisement categories to cease to be displayed.

9. The method of claim 1, wherein the step of inserting one or more selectable advertisement categories into the electronic communication includes the steps of:
causing a first subset of the one or more advertisement categories to be displayed upon the display of the modified electronic communication; and
causing a second subset of the one or more advertisement categories to be displayed after a predetermined time delay has passed.

10. The method of claim 1, wherein the step of inserting one or more selectable advertisement categories into the electronic communication includes the step of embedding a user interface in the electronic communication, the user interface being configured to display the one or more selectable advertisement categories in Flash, JavaScript, hypertext mark-up language (HTML) or a combination thereof.

11. The method of claim 1, wherein the step of inserting one or more selectable categories of advertisements into the electronic communication includes the step of embedding a hyperlink linked to each of the one or more selectable advertisement categories in the electronic communication.

12. The method of claim 1, wherein the electronic communication includes an electronic mail (email), a short message service (SMS) message, a Multimedia Messaging Service (MMS) message or an instant messaging (IM) message.

13. The method of claim 1, wherein the one or more selectable advertisement categories include one or more of news, entertainment, sports, food and dining, automobile, flights and holidays, finance, television, retail and shopping.

14. A computer-readable medium comprising a plurality of instructions for a computer or a processor to execute to:
receive an electronic communication;
insert one or more selectable advertisement categories into the electronic communication to form a modified electronic communication, the one or more selectable advertisement categories being configured to be displayed upon display of the modified electronic communication and each being associated with one or more advertisements; and
send the modified electronic communication

15. An electronic communication comprising:
an electronic message; and
one or more selectable advertisement categories each being associated with one or more advertisements and configured to be displayed upon display of the electronic message.

16. A method of advertising in an electronic communication, the method comprising the steps of:
receiving at least one electronic communication from a sender eligible for a reward;
inserting an advertisement or an advertisement category into each of the at least one electronic communication to form at least one modified electronic communication, the advertisement or the advertisement category being configured to be displayed upon display of the at least one modified electronic communication;
sending the at least one modified electronic communication;
increasing a probability of the sender to be awarded the reward.

17. The method of claim 16, wherein the step of increasing a probability of the sender to be awarded the reward includes the step increasing the probability based on the number of the at least one modified electronic communication sent.

18. The method of claim 16, wherein the step of receiving at least one electronic communication includes the step of receiving at least a predetermined number of electronic communications.

19. The method of claim 18, wherein the step of receiving at least a predetermined number of electronic communications includes the step of receiving at least a predetermined number of electronic communications over a predetermined period of time.

20. A computer-readable medium comprising a plurality of instructions for a computer or a processor to execute to:
receive at least one electronic communication from a sender eligible for a reward;
insert an advertisement or an advertisement category into each of the at least one electronic communication to form at least one modified electronic communication, the advertisement or the advertisement category being configured to be displayed upon display of the at least one modified electronic communication;
send the at least one modified electronic communication;
increase a probability of the sender to be awarded the reward.
